(19) United States
(12) Patent Application Publication
(10) Pub. No.: US 2026/0275200 A1
(43) Pub. Date: Sep. 17, 2026

(54) METHODS FOR PREPARING BIODIESEL BY DIRECTIONAL REGULATING HYDRODEOXYGENATION OF BIOLOGICAL OILS

(71) Applicant: DALIAN UNIVERSITY OF TECHNOLOGY, Dalian (CN)

(72) Inventors: Changhai LIANG, Dalian (CN); Chenxi ZHAO, Dalian (CN); Wenjun ZHU, Dalian (CN)

(73) Assignee: DALIAN UNIVERSITY OF TECHNOLOGY, Dalian (CN)

(21) Appl. No.: 19/530,346

(22) Filed: Feb. 5, 2026

(30) Foreign Application Priority Data
Mar. 13, 2025 (CN) 202510298931.2

(51) Int. Cl. C10G 3/00; B01J 21/06; B01J 23/83; B01J 37/04; B01J 37/12

(52) U.S. Cl. CPC C10G 3/54; B01J 21/066; B01J 23/83; B01J 37/04; B01J 37/12; C10G 2300/1011; C10G 2300/70; C10G 2400/04

(57) ABSTRACT

Discloses is a method for preparing biodiesel by directional regulating hydrodeoxygenation of biological oils, including: dissolving the biological oils in a solvent, mixing with hydrogen gas, injecting into a fixed-bed reactor, performing a hydrodeoxygenation reaction using an atom-substituted zirconia supported Ni catalyst, controlling the biological oils to directionally generate alkanes having corresponding carbon numbers or alkanes having one less carbon atom by changing doping elements of a support in the atom-substituted zirconia supported Ni catalyst; and obtaining the biodiesel. A chemical formula of the atom-substituted zirconia supported Ni catalyst is Ni/xMZrO₂, where x is a molar percentage of M, and Mis Ce or Ti. By using additives Ce and Ti to functionalize a support of Ni/ZrO₂ catalyst, it can regulate chemical properties of the catalyst, achieve controllable adjustment of hydrodeoxygenation activity and product selectivity for biological oils, improve selectivity of a target alkane component, and obtain high-quality biodiesel.

### CROSS-REFERENCE TO RELATED APPLICATIONS

This application claims priority to the Chinese Patent Application No. 202510298931.2, filed on Mar. 13, 2025, the contents of which are hereby incorporated by reference.

### TECHNICAL FIELD

The present disclosure relates to a field of biodiesel preparation technology, and in particular to a method for preparing biodiesel by directional regulating hydrodeoxygenation of biological oils.

### BACKGROUND

In recent years, biological oils replace traditional fossil fuels for energy supply in application processes across various industries due to their advantages such as renewability, cleanliness, and abundant reserves. However, constituent molecules of the biological oils contain a large number of oxygen atoms and their direct use as fuels has disadvantages such as poor stability, low calorific value, and high viscosity. Thus, it is necessary to carry out hydrodeoxygenation treatment on the biological oils to remove oxygen atoms, thereby improving quality of oil products and obtaining biodiesel with high calorific value and cleanliness. Therefore, the development of efficient and stable catalysts has become a key to vigorously advancement of clean energy preparation from the biological oils.

Currently, commonly used hydrodeoxygenation catalysts for the biological oils are mainly divided into noble metal catalysts and metal sulfide catalysts. However, the exorbitant cost of noble metal catalysts limit their large-scale application, while metal sulfides suffer from catalytic activity deactivation and environmental contamination due to sulfur loss during a reaction process. The Chinese Patent Application with publication number CN117797832A discloses a preparation method for a polymetallic sulfide hydrodeoxygenation catalyst, which is applied to hydrodeoxygenation of waste oils to prepare the biodiesel. Although the method exhibits a high deoxygenation rate and a high alkane yield, the preparation process of the catalyst is relatively complex, and in-situ sulfidation using sulfur powder causes product contamination. Therefore, the development and application of clean non-noble metal-based catalysts have attracted much attention.

There are mainly two pathways for hydrodeoxygenation of the biological oils. One pathway is a direct hydrodeoxygenation pathway (HDO). The HDO pathway removes oxygen atoms in a form of H₂O and generates alkanes having corresponding carbon numbers. The HDO process does not involve carbon removal, which has higher atom economy. However, the HDO process inevitably generates water, which easily damages a structure of the catalyst, leading to irreversible decrease in catalytic activity. Therefore, the HDO process imposes higher requirements on water resistance of the catalyst. The other pathway is a hydrodecarboxylation/hydrodecarbonylation pathway (DCO). The DCO pathway removes oxygen atoms in a form of CO/CO₂, thereby generating the alkanes having one less carbon atom. Although the hydrodecarboxylation pathway generates only a trace amount of water or even no water, it generates CO₂/CO during the reaction process, causing certain carbon loss.

The Chinese Patent Application with publication number CN111715229A discloses a method for preparing biofuel oil by hydrodeoxygenation of methyl laurate catalyzed by a sulfur-free nickel-based catalyst Ni/CeO₂—TiO₂. Under conditions of a mass ratio of reaction raw material methyl laurate to the catalyst of 10, a reaction temperature of 300° C., a hydrogen pressure of 2.5 MPa, and a reaction time of 4 h, a mass yield of biofuel oil product can reach 96%, and a mass percentage of n-undecane in the product is 98%. In the process, the obtained product using the catalyst is mainly n-undecane. However, the product does not meet requirements of atom economy. Thus, how to controllably regulate directional selectivity between HDO and DCO pathways in the catalytic conversion of the biological oils based on design and modification of the catalyst is a key technical problem to be addressed.

In summary, existing research on hydrodeoxygenation of the biological oils to prepare the biodiesel still has a large research space. Based on a current research status, the present disclosure proposes a method for preparing biodiesel by directional regulating hydrodeoxygenation of biological oils.

### SUMMARY

One or more embodiments of the present disclosure provide a method for preparing biodiesel by directional regulating hydrodeoxygenation of biological oils, the method comprising: dissolving the biological oils in a solvent to obtain an oil mixed solution with a mass concentration of 1.0% to 20%; mixing the oil mixed solution with hydrogen gas to obtain a mixture and injecting the mixture into a fixed-bed reactor; performing a hydrodeoxygenation reaction using an atom-substituted zirconia supported Ni catalyst; controlling the biological oils to directionally generate alkanes having corresponding carbon numbers or alkanes having one less carbon atom by changing a coordination structure of a support and heteroatoms in the atom-substituted zirconia supported Ni catalyst; and obtaining the biodiesel, wherein a chemical formula of the atom-substituted zirconia supported Ni catalyst is Ni/xMZrO₂, where x is a molar percentage of M in the support and has a value of 1% to 20%, Mis at least one of Ce or Ti, and a loading amount of Ni is 5 wt. % to 50 wt. %; and the atom-substituted zirconia supported Ni catalyst is prepared by a process including: 1) mixing and dissolving at least one of a zirconium salt, a cerium salt, or a titanium salt in deionized water to obtain a metal precursor salt solution; adding urea to the metal precursor salt solution and stirring thoroughly until dissolution is completed to obtain a metal precursor mixed solution; placing the metal precursor mixed solution in an autoclave for heating, and filtering to obtain a precipitate; washing and drying the precipitate; and calcining the precipitate in an O₂/Ar mixed atmosphere to obtain an atom-substituted zirconia support; and 2) adding the atom-substituted zirconia support and a nickel salt to the deionized water, stirring uniformly, performing rotary evaporation and drying, and then calcining in the O₂/Ar mixed atmosphere to obtain the atom-substituted zirconia supported Ni catalyst.

### BRIEF DESCRIPTION OF THE DRAWINGS

FIG. 1 is an X-ray diffraction pattern of catalyst Ni/ZrO₂ of COMPARATIVE EXAMPLE 1, catalyst Ni/5CeZrO₂ of EXAMPLE 3, and catalyst Ni/10TiZrO₂ of EXAMPLE 7 according to the present disclosure.

FIG. 2 is a transmission electron microscopy (TEM) image of catalyst Ni/ZrO₂ of COMPARATIVE EXAMPLE 1, catalyst Ni/5CeZrO₂ of EXAMPLE 3, and catalyst Ni/10TiZrO₂ of EXAMPLE 7 according to the present disclosure, where a is Ni/10TiZrO₂, b is Ni/ZrO₂, and c is Ni/5CeZrO₂.

FIG. 3 is an X-ray photoelectron spectroscopy Zr 3d (XPS Zr 3d) spectrum of catalyst Ni/ZrO₂ of COMPARATIVE EXAMPLE 1, catalyst Ni/5CeZrO₂ of EXAMPLE 3, and catalyst Ni/10TiZrO₂ of EXAMPLE 7 according to the present disclosure.

### DETAILED DESCRIPTION

To more clearly illustrate the technical solutions of the embodiments of the present disclosure, the drawings used in the description of the embodiments are briefly introduced below. Obviously, the drawings in the following description are merely some examples or embodiments of the present disclosure. For a person of ordinary skill in the art, the present disclosure may be applied to other similar scenarios based on these drawings without reactive efforts. Unless obviously obtained from the context or the context illustrates otherwise, the same numeral in the drawings refers to the same structure or operation.

As shown in the present disclosure and the claims, unless the context clearly indicates an exception, the terms “a”, “an”, “one”, and/or “the” are not intended to be singular only, but may also include the plural. Generally, the terms “include” and “comprise” merely indicate inclusion of explicitly identified steps and elements. These steps and elements do not constitute an exclusive list, and the method or device may also include other steps or elements.

The present disclosure uses flowcharts to illustrate operations performed by a system according to embodiments of the present disclosure. It should be understood that preceding or subsequent operations are not necessarily performed precisely in order. On the contrary, the steps may be processed in reverse order or simultaneously. At the same time, other operations may be added to these processes, or one or more steps may be removed from these processes.

One or more embodiments of the present disclosure provide a method for preparing biodiesel by directional regulating hydrodeoxygenation of biological oils, including the following steps: dissolving the biological oils in a solvent to obtain an oil mixed solution with a mass concentration of 1.0% to 20%; mixing the oil mixed solution with hydrogen gas to obtain a mixture and injecting the mixture into a fixed-bed reactor; performing a hydrodeoxygenation reaction using an atom-substituted zirconia supported Ni catalyst; controlling the biological oils to directionally generate alkanes having corresponding carbon numbers or alkanes having one less carbon atom by changing a coordination structure of a support and heteroatoms in the atom-substituted zirconia supported Ni catalyst; and obtaining the biodiesel. A chemical formula of the atom-substituted zirconia supported Ni catalyst is Ni/xMZrO₂, where x is a molar percentage of M in the support and has a value of 1% to 20%, M is at least one of Ce or Ti, and a loading amount of Ni is 5 wt. % to 50 wt. %. The atom-substituted zirconia supported Ni catalyst is prepared by a process including: 1) 1) mixing and dissolving at least one of a zirconium salt, a cerium salt, or a titanium salt in deionized water to obtain a metal precursor salt solution; adding urea to the metal precursor salt solution and stirring thoroughly until dissolution is completed to obtain a metal precursor mixed solution; placing the metal precursor mixed solution in an autoclave for heating, and filtering to obtain a precipitate; washing and drying the precipitate; and calcining the precipitate in an O₂/Ar mixed atmosphere to obtain an atom-substituted zirconia support; and 2) adding the atom-substituted zirconia support and a nickel salt to the deionized water, stirring uniformly, performing rotary evaporation and drying, and then calcining in the O₂/Ar mixed atmosphere to obtain the atom-substituted zirconia supported Ni catalyst.

The biological oils refer to oils extracted or converted from biomass, which are mainly composed of triglycerides.

In some embodiments, the biological oils are a renewable, clean, and abundant lipid compound. The biological oils may be derived from plants, animals, or microorganisms, which may serve as raw material for various industrial applications including biofuel production.

In some embodiments, the biological oils may include one or more of palm oils, soybean oils, or rapeseed oils.

In some embodiments, the biological oils may also include other vegetable oils, animal fats, or the like. For example, the biological oils may be sunflower seed oil, corn oil, peanut oil, olive oil, lard, tallow, etc.

In some embodiments, the biological oils may also be other types of biological oils, such as waste cooking oil or microalgae oil.

Using the biological oils such as the palm oil, the soybean oil, or the rapeseed oil as raw material for producing the biodiesel provides a sustainable and environmentally friendly alternative to fossil fuels, which has many advantages such as cleanliness, high reserves, and low cost.

The solvent refers to a liquid substance capable of dissolving the biological oils without undergoing a chemical reaction with the biological oils.

In some embodiments, the solvent may be at least one of n-decane, cyclohexane, or n-heptane.

In some embodiments, the solvent may be prepared by mixing any two or three of the n-decane, the cyclohexane, and the n-heptane in any ratio. For example, a mixture of n-decane and cyclohexane may be selected as the solvent according to a type of biological oils and specific requirements of the reaction to achieve an optimal dissolution effect and reaction performance. As another example, a mixture of n-decane, cyclohexane, and n-heptane may be used as the solvent to fully utilize advantages of various solvents.

In some embodiments, the solvent may also be other types of alkane solvents, cycloalkane solvents, or aromatic hydrocarbon solvents, such as n-octane, toluene.

Using one or more of the n-decane, the cyclohexane, and the n-heptane as the solvent allows the biological oils to be effectively dissolved and mixed with the hydrogen gas, and then injected into the fixed-bed reactor for the hydrodeoxygenation reaction. These solvents have good chemical stability and are not prone to side reactions under hydrodeoxygenation reaction conditions. The solvents can provide a stable reaction environment for the catalyst, helping ensure smooth progress of the hydrodeoxygenation reaction of the biological oils and improving catalytic efficiency and product yield of the catalyst, thereby obtaining high-quality biodiesel.

The oil mixed solution refers to a solution formed by dissolving the biological oils in the solvent.

The mass concentration of the oil mixed solution refers to a percentage of a mass of the biological oils to a total mass of the oil mixed solution.

In some embodiments, the mass concentration of the oil mixed solution may be 2.0% to 20%, 0.5% to 10%, 1.0% to 15%, 2.0% to 10%, 4.0% to 8.0%, etc. For example, the mass concentration of the oil mixed solution may be 1.0%, 2.0%, 5.0%, 8.0%, 10%, 12%, 15%, 18%, or 20%.

In some embodiments, before the hydrodeoxygenation reaction is performed, the atom-substituted zirconia supported Ni catalyst is subjected to in-situ reduction in the fixed-bed reactor.

In some embodiments, before the hydrodeoxygenation reaction is performed, the atom-substituted zirconia supported Ni catalyst is subjected to in-situ reduction in the fixed-bed reactor for 1.5 h to 2.5 h at a reduction temperature of 300° C. to 400° C.

In-situ reduction refers to a process in which a catalyst is activated by introducing a reducing gas and treating the catalyst at a specific temperature in an actual reaction equipment (e.g., the fixed-bed reactor) before performing a main catalytic reaction.

In some embodiments, the reducing gas is hydrogen gas (H₂).

For the atom-substituted zirconia supported Ni catalyst, a purpose of the in-situ reduction is to reduce nickel oxides (e.g., nickel oxide (NiO)) in the catalyst to metallic nickel (Ni) with catalytic activity, thereby enabling the catalyst to effectively catalyze the hydrodeoxygenation reaction.

In some embodiments, the chemical formula of the atom-substituted zirconia supported Ni catalyst is Ni/xMZrO₂, where x is the molar percentage of M in the support and has a value of 1% to 20%, M is at least one of Ce or Ti, and a loading amount of Ni is 5 wt. % to 50 wt. %.

The atom-substituted zirconia supported Ni catalyst is a material used for catalyzing hydrodeoxygenation of the biological oils. A support of the catalyst is zirconia (ZrO₂), and a portion of zirconium (Zr) atoms in the support are substituted by heteroatoms M (e.g., cerium (Ce) or titanium (Ti)), forming a coordination structure such as M-O—Zr.

The support refers to a material used to support an active catalytic component (e.g., Ni) and may participate in a catalytic reaction. The support specifically refers to atom-substituted zirconia herein.

The heteroatom (M) refers to another metal atom doped into a zirconia lattice to substitute Zr atom. In some embodiments, M is at least one of Ce or Ti. For example, M may be Ce, Ti, or a combination of Ce and Ti.

The molar percentage (x) of the heteroatom M in the support may be 1% to 10%, 5% to 15%, 10% to 20%, 10% to 15%, etc. M may be one or two of Ce and Ti. This substitution changes an electronic state and chemical properties of the zirconia support itself, thereby affecting Ni active sites loaded on the support, thus achieving selective regulation of the hydrodeoxygenation reaction.

The loading amount of Ni refers to a percentage (wt. %) of a mass of Ni to a total mass of the entire catalyst. In some embodiments, the loading amount of Ni may be 5 wt. % to 50 wt. %, 10 wt. % to 50 wt. %, 15 wt. % to 50 wt. %, 20 wt. % to 50 wt. %, 25 wt. % to 50 wt. %, 20 wt. % to 40 wt. %, 25 wt. % to 35 wt. %, etc. For example, the loading amount of Ni may be 5 wt. %, 12 wt. %, 25 wt. %, 30 wt. %, 35 wt. %, and 50 wt. %.

The fixed-bed reactor refers to a reaction device in which a catalyst is fixed inside the reactor and a reaction fluid flows through a catalyst bed. The fixed-bed reactor may adopt various structures, such as a tubular fixed-bed reactor, a multi-tubular fixed-bed reactor.

In some embodiments, a reduction time may be 1.5 h to 2.5 h, 1.6 h to 2.4 h, 1.7 h to 2.3 h, 1.8 h to 2.2 h, 1.9 h to 2.1 h, etc. For example, the reduction time may be 1.5 h, 1.7 h, 2.1 h, 2.5 h, or the like, or any other time that may ensure sufficient activation of the catalyst without significant loss of activity.

In some embodiments, the reduction temperature may be 300 to 400° C., 310 to 390° C., 320 to 380° C., 330 to 370° C., 340 to 360° C., or 360 to 400° C., or the like. For example, the reduction temperature may be 300° C., 305° C., 326° C., 355° C., 385° C., 395° C., or 400° C., or the like, or any other temperature that may effectively activate the catalyst and avoid structural damage to the catalyst.

In some embodiments, before the hydrodeoxygenation reaction is performed, the atom-substituted zirconia supported Ni catalyst is subjected to in-situ reduction in the fixed-bed reactor to activate the catalyst, enabling the catalyst to efficiently catalyze the hydrodeoxygenation reaction of the biological oils. By performing in-situ reduction on the atom-substituted zirconia supported Ni catalyst with a specific reduction time and a specific reduction temperature before the hydrodeoxygenation reaction, Ni species can be effectively reduced to highly dispersed and active metallic Ni.

The hydrodeoxygenation reaction refers to a process of removing oxygen atoms from biological oils in a form of water (H₂O), carbon dioxide (CO₂), or carbon monoxide (CO) through a catalyst in the presence of hydrogen gas, thereby generating alkanes. The hydrodeoxygenation reaction aims to improve quality of an oil product, giving the oil product a higher heating value, better stability, and lower viscosity, so that the oil product can be used as biodiesel.

In some embodiments, a reducing agent for the hydrodeoxygenation reaction may include hydrogen gas (H₂). For example, the reducing agent may be provided in a form of pure hydrogen gas or a mixture of hydrogen gas and an inert gas, e.g., nitrogen (N₂), argon (Ar), or the like.

In some embodiments, during the hydrodeoxygenation reaction, a concentration of the biological oils is 1.0 wt. % to 20 wt. %, a temperature is 160° C. to 300° C., a hydrogen pressure is 0.2 MPa to 4 MPa, a weight hourly space velocity (WHSV) is 0.2 h⁻¹ to 4.8 h⁻¹, and a ratio of the hydrogen gas to the biological oils is (200-800):1.

The concentration of the biological oils refers to a mass percentage (wt. %) of the biological oils in a solvent.

In some embodiments, the concentration of the biological oils may be 1.0 wt. % to 18 wt. %, 4.0 wt. % to 16 wt. %, 6.0 wt. % to 14 wt. %, 8.0 wt. % to 12 wt. %, or the like. For example, the concentration of the biological oils may be 1.0 wt. %, 2.0 wt. %, 5 wt. %, 10 wt. %, 15 wt. %, or 20 wt. %.

In some embodiments, during the hydrodeoxygenation reaction, a reaction temperature may be 160° C. to 240° C., 170° C. to 260° C., 180° C. to 280° C., 200° C. to 260° C., or 220° C. to 250° C., or the like. For example, the reaction temperature may be 160° C., 165° C., 210° C., 245° C., 285° C., or 300° C., or the like.

In some embodiments, during the hydrodeoxygenation reaction, the hydrogen pressure may be 0.5 MPa to 3.5 MPa, 1 MPa to 3 MPa, or 1.5 MPa to 2.5 MPa, or the like. For example, the hydrogen pressure may be 0.2 MPa, 1 MPa, 2 MPa, 3 MPa, or 4 MPa.

The WHSV refers to a mass of a reactant (e.g., the biological oils) passing through a unit mass of the catalyst per unit time. A unit of the WHSV is typically expressed as h⁻¹. The WHSV is a parameter that measures a residence time of the reactant on the catalyst. A higher WHSV indicates a shorter residence time of the reactant.

In some embodiments, during the hydrodeoxygenation reaction, the WHSV may be 0.2 h⁻¹ to 4 h⁻¹, 1 h⁻¹ to 3 h⁻¹, 1.5 h⁻¹ to 2.5 h⁻¹, 2.5 h⁻¹ to 3.5 h⁻¹, 3.5 h⁻¹ to 4.5 h⁻¹, 4 h⁻¹ to 4.8 h⁻¹, or the like. For example, the WHSV may be 0.2 h⁻¹, 0.5 h⁻¹, 1 h⁻¹, 2 h⁻¹, 3 h⁻¹, or 4.8 h⁻¹.

The ratio of the hydrogen gas to the biological oils typically refers to a ratio of a volume flow rate of the hydrogen gas to a volume flow rate of the biological oils, or a ratio of molar flow rates. For example, the ratio refers to a molar ratio or a volume ratio of the hydrogen gas to the biological oils upon entering a reactor.

In some embodiments, during the hydrodeoxygenation reaction, the ratio of the hydrogen gas to the biological oils is (200-750):1, (300-700):1, (400-600):1, or (500-800):1, or the like. In some embodiments, the ratio of the hydrogen gas to the biological oils may be 200:1, 260:1, 350:1, 550:1, 650:1, 750:1, or 800:1.

By precisely controlling the concentration of the biological oils, the temperature, the hydrogen pressure, the WHSV, and the ratio of the hydrogen gas to the biological oils during the hydrodeoxygenation reaction, efficient conversion of the biological oils and selective regulation of a target product can be achieved, helping improve hydrodeoxygenation efficiency of the biological oils and achieving high selectivity of the target biodiesel product, thereby obtaining high-quality biodiesel.

In some embodiments, the biodiesel is obtained by performing the hydrodeoxygenation reaction using the atom-substituted zirconia supported Ni catalyst and controlling the biological oils to directionally generate alkanes having corresponding carbon numbers or alkanes having one less carbon atom by changing a coordination structure of a support and heteroatoms in the atom-substituted zirconia supported Ni catalyst.

In some embodiments, the atom-substituted zirconia supported Ni catalyst is used as a catalyst for hydrodeoxygenation of the biological oils to prepare biodiesel. The heteroatom M occupies a spatial site of an original Zr atom in a crystal structure of ZrO₂, forming an M-O—Zr coordination structure that precisely modulates an electronic state and chemical properties of the ZrO₂ support, thereby controlling the biological oils to directionally generate alkanes having corresponding carbon numbers or alkanes having one less carbon atom.

The coordination structure refers to a spatial configuration formed by bonding between atoms through chemical bonds. In the atom-substituted zirconia supported Ni catalyst, the coordination structure particularly refers to an M-O—Zr bonding structure formed between the heteroatom (M), an oxygen atom (O), and a zirconium atom (Zr), which affects an electronic state and chemical properties of the support.

Controlling the biological oils to directionally generate alkanes having corresponding carbon numbers or alkanes having one less carbon atom refers to causing the hydrodeoxygenation reaction to predominantly tend to generate one of two alkane products with different counts of carbon atoms by adjusting the coordination structure of the support and the heteroatom in the atom-substituted zirconia supported Ni catalyst.

When alkanes having corresponding carbon numbers are generated, this typically means that a reaction via a direct hydrodeoxygenation (HDO) pathway has occurred. In the reaction, oxygen atoms are removed in a form of water (H₂O), and a carbon chain length remains unchanged. For example, if fatty acids in the biological oils have 18 carbon atoms, alkanes having 18 carbon atoms are predominantly generated.

When alkanes having one less carbon atom are generated, this typically means that a reaction via a hydrodecarboxylation/hydrodecarbonylation (DCO) pathway has occurred. In the reaction, oxygen atoms are removed in a form of carbon dioxide (CO₂) or carbon monoxide (CO), resulting in a reduction of the carbon chain by one carbon atom. For example, if fatty acids in the biological oils have 18 carbon atoms, alkanes having 17 carbon atoms are predominantly generated.

By regulating the coordination structure of the catalyst, the selectivity of these two deoxygenation pathways can be controlled, thereby directionally obtaining biodiesel components with a target count of carbon atoms. For example, the reaction may be made to predominantly generate one of pentadecane (C15) or hexadecane (C16).

The biodiesel refers to a clean fuel obtained after hydrodeoxygenation treatment of the biological oils, which is mainly composed of alkanes. The alkane is typically a normal alkane or a branched alkane, and a count of carbon atoms in the alkane is the same as or one less than a count of carbon atoms in a fatty acid chain of the biological oils.

In some embodiments, the preparation process of the atom-substituted zirconia supported Ni catalyst includes step 1) and step 2) below.

Step 1) mixing and dissolving at least one of a zirconium salt, a cerium salt, or a titanium salt in deionized water to obtain a metal precursor salt solution; adding urea to the metal precursor salt solution and stirring thoroughly until dissolution is completed to obtain a metal precursor mixed solution; placing the metal precursor mixed solution in an autoclave for heating, and filtering to obtain a precipitate; washing and drying the precipitate; and calcining the precipitate in an O₂/Ar mixed atmosphere to obtain an atom-substituted zirconia support.

The metal precursor salt solution refers to a solution formed by dissolving one or two of the zirconium salt, the cerium salt, or the titanium salt in the deionized water.

In some embodiments, the zirconium salt is ZrO(NO₃)₂·xH₂O, the cerium salt is Ce(NO₃)₃·6H₂O, and the titanium salt is Ti(SO₄)₂.

The zirconium salt refers to an inorganic salt or an organic salt containing zirconium.

In some embodiments, the zirconium salt may be zirconyl nitrate hydrate (ZrO(NO₃)₂·xH₂O), where x represents a count of water molecules bound in the zirconyl nitrate hydrate. In some embodiments, x may be an integer, e.g., 4 or 5, or a non-integer value, indicating an indefinite amount of hydration.

In some embodiments of the present disclosure, the zirconium salt may be in various forms, e.g., zirconyl chloride, zirconium acetate, or the like, as long as the zirconium salt may stably exist in an aqueous solution and provide zirconium ions, and may be effectively converted into a desired zirconia structure during the catalyst preparation process.

The cerium salt refers to a compound containing cerium (Ce). In some embodiments, the cerium salt is cerium (III) nitrate hexahydrate (Ce(NO₃)₃·6H₂O). During heat treatment, cerium atoms in cerium (III) nitrate hexahydrate readily combine with oxygen atoms, thereby directly incorporating into a lattice of zirconia, achieving an effective solid solution of cerium atoms in the crystal structure of zirconia.

The titanium salt refers to a compound containing titanium (Ti). In some embodiments, the titanium salt is titanium (IV) sulfate (Ti(SO₄)₂). Similar to nitrate, titanium (IV) sulfate also has good water solubility, which is beneficial for forming a uniform metal precursor in a solution. In addition, sulfate ions (SO₄²⁻) are prone to volatilization or decomposition during high-temperature calcination, which helps to form a pure oxide support free of sulfur(S).

In some embodiments, one or two of the zirconium salt, the cerium salt, or the titanium salt are mixed and dissolved in the deionized water to obtain a metal precursor salt solution. For example, when preparing a catalyst containing only cerium as the heteroatom, zirconyl nitrate hydrate (ZrO(NO₃)₂·xH₂O) and cerium (III) nitrate hexahydrate (Ce(NO₃)₃·6H₂O) are mixed. As another example, when preparing a catalyst containing only titanium as the heteroatom, zirconyl nitrate hydrate (ZrO(NO₃)₂·xH₂O) and titanium (IV) sulfate (Ti(SO₄)₂) are mixed. When preparing a catalyst containing both cerium and titanium as heteroatoms, zirconyl nitrate hydrate (ZrO(NO₃)₂·xH₂O), cerium (III) nitrate hexahydrate (Ce(NO₃)₃·6H₂O), and titanium (IV) sulfate (Ti(SO₄)₂) are mixed.

The selection of these specific zirconium salt, cerium salt, and titanium salt is beneficial for achieving directional regulation of hydrodeoxygenation of the biological oils to prepare the biodiesel, ensuring that zirconium, cerium, and titanium elements can be introduced into the catalyst support in precise proportions and effectively modulating the electronic state and chemical properties of the zirconia support itself, thereby regulating the hydrodeoxygenation activity and product selectivity of the catalyst, achieving directional generation of alkanes having corresponding carbon numbers or alkanes having one less carbon atom from the biological oils, ultimately obtaining high-quality biodiesel.

The stirring thoroughly until dissolution is completed refers to continuously stirring until the urea is completely dissolved in the metal precursor salt solution, forming a uniform metal precursor mixed solution.

The metal precursor mixed solution refers to a solution formed after mixing and dissolving the metal precursor salt solution with the urea.

In some embodiments, in the step 1), a molar ratio of the urea to the metal precursor salt solution is 10:1, a heating temperature of the autoclave is 120° C. to 180° C., a heating time of the autoclave is 10 h to 20 h, a calcination temperature is 500° C. to 650° C., and a calcination time is 3 h to 5 h.

In some embodiments, in step 1), the molar ratio of the urea to the metal precursor salt solution is 10:1. For example, if the metal precursor salt solution contains X moles of metal precursor salt, 10× moles of the urea are added. By controlling the molar ratio of the urea to the metal precursor salt solution at 10:1, slow hydrolysis of the urea can be ensured during the hydrothermal reaction, thereby promoting uniform precipitation of metal ions and facilitating the formation of a uniform atom-substituted zirconia support with a specific crystal structure. In some embodiments, the molar ratio of the urea to the metal precursor salt solution may be adjusted according to actual requirements. For example, the molar ratio may also be 9:1, 11:1, or fluctuate within a small range based on 10:1.

In some embodiments, in step 1), the heating temperature of the autoclave may be 120° C. to 180° C. The temperature range facilitates moderate hydrolysis of the urea under hydrothermal conditions and promotes uniform precipitation and crystallization of the metal precursor. In some embodiments, the heating temperature may be 120° C. to 150° C., 130° C. to 170° C., or 140° C. to 160° C. For example, the heating temperature may be 120° C., 135° C., 145° C., 165° C., 175° C., or 180° C. In some embodiments, the heating temperature may be adjusted according to the solvent of the reaction system, the type and concentration of the metal salt, and the desired product morphology.

In some embodiments, in step 1), the heating time of the autoclave is 10 h to 20 h. The sufficient heating time ensures that the metal precursor fully reacts and crystallizes under hydrothermal conditions, forming a stable support precursor. In some embodiments, in step 1), the heating time may also be 10 h to 18 h, 12 h to 16 h, 13 h to 17 h, or 14 h to 15 h. For example, the heating time may be 10 h, 11 h, 13 h, 16 h, 18 h, 19 h, 20 h, etc.

In some embodiments, the heating time may also be adjusted according to factors such as the size of the autoclave, the heating manner, and the morphology of the target support.

In some embodiments, after heating in the autoclave and then filtering to obtain a precipitate, the precipitate is washed and dried.

In some embodiments, the drying may be performed in a dryer at a temperature of about 100° C. for 12 h to 16 h. For example, the precipitate is dried overnight at a temperature of 100° C.

In some embodiments, after washing and drying the precipitate, the calcination is performed in an O₂/Ar mixed atmosphere to obtain the atom-substituted zirconia support.

The O₂/Ar mixed atmosphere refers to a mixed gas environment composed of oxygen and argon, used to control the oxidation-reduction conditions during the calcination process.

In some embodiments, in step 1), the calcination temperature is 500° C. to 650° C. Within this temperature range, the support precursor can be fully dehydrated and crystallized to form a stable zirconia crystal structure, and the heteroatom can successfully substitute zirconium atom to form an M-O—Zr coordination structure. In some embodiments, the calcination temperature may also be 510° C. to 640° C., 520° C. to 630° C., 540° C. to 610° C., 560° C. to 600° C., 580° C. to 590° C., 590° C. to 630° C., etc. For example, the calcination temperature is 500° C., 530° C., 575° C., 590° C., 610° C., 630° C., 650° C., etc.

In some embodiments, the calcination temperature may also be adjusted according to factors such as the type of selected heteroatom, the crystal phase stability of zirconia, and the desired catalyst activity.

In some embodiments, in step 1), the calcination time is 3 h to 5 h. The appropriate calcination time ensures that the support material is fully crystallized and structurally stable, while avoiding excessive calcination that causes excessive grain growth or structural damage. In some embodiments, the calcination time may be 3 h to 3.5 h, 3.2 h to 3.6 h, 3.3 h to 4.5 h, 3.8 h to 4.6 h, 4.5 h to 4.8 h, or 4.7 h to 5 h, etc. For example, the calcination time may be 3 h, 3.4 h, 3.9 h, 4.2 h, 4.7 h, or 5 h, etc.

In some embodiments, the calcination time may also be adjusted according to factors such as calcination atmosphere, heating rate of the calcination furnace, and a size of support material to ensure the performance of the support.

In some embodiments, the heating temperature of the autoclave is 150° C., the heating time is 12 h, the calcination temperature is 600° C., and the calcination time is 4 h.

By precisely controlling the heating temperature, the heating time, the calcination temperature, and the calcination time of the autoclave, the formation process and structural characteristics of the atom-substituted zirconia support (e.g., xMZrO₂ in Ni/xMZrO₂) can be effectively regulated. Optimization of these parameters helps ensure that heteroatoms (e.g., Ce or Ti) successfully substitute original Zr atoms in the crystal structure of zirconia (ZrO₂), forming a support with a specific M-O—Zr coordination structure, which is beneficial for improving the efficiency and selectivity of hydrodeoxygenation of the biological oils to prepare the biodiesel.

The precise molar ratio of the urea to the metal precursor salt solution helps form a uniform precipitate and avoid agglomeration, thereby preparing a highly dispersed atom-substituted zirconia support. Optimized heating temperature and heating time ensure sufficient reaction and crystallization of the metal precursor during the hydrothermal synthesis process, enabling heteroatoms to more effectively substitute zirconium atoms and form a stable M-O—Zr coordination structure. Appropriate calcination temperature and calcination time ensure the crystal phase stability and high specific surface area of the support material while avoiding excessive grain growth, thereby providing good support for subsequent loading of nickel active components. These regulations help precisely change the electronic state and chemical properties of the zirconia support itself, enabling the prepared catalyst to achieve directional regulation of product selectivity during the hydrodeoxygenation of the biological oils to prepare the biodiesel, thereby obtaining higher-quality biodiesel.

Step 2) adding the atom-substituted zirconia support and the nickel salt to the deionized water, stirring uniformly, performing rotary evaporation and drying, and then calcining in the O₂/Ar mixed atmosphere to obtain the atom-substituted zirconia supported Ni catalyst.

The nickel salt refers to an inorganic salt or an organic salt containing nickel, e.g., nickel nitrate (Ni(NO₃)₂·6H₂O), nickel chloride (NiCl₂), or the like.

The rotary evaporation refers to a process for rapidly evaporating a solvent, concentrating a solution, or recovering a solid product under reduced pressure and heating conditions by using a rotary evaporator.

In some embodiments, the drying may be performed in a dryer at a temperature of about 100° C. for 12 h to 16 h. For example, the drying is performed overnight at a temperature of 100° C.

More descriptions regarding the O₂/Ar mixed atmosphere may be found in the corresponding description above.

In some embodiments, in step 2), a stirring time is 8 h to 12 h, a calcination temperature is 340° C. to 450° C., and a calcination time is 3 h to 5 h.

In some embodiments, in step 2), the stirring time may be 8 h to 10 h, 9 h to 11 h, 10 h to 12 h, etc. For example, the stirring time may be 8 h, 9 h, 10 h, 11 h, or 12 h.

In some embodiments, in step 2), the calcination temperature may be 370° C. to 440° C., 360° C. to 420° C., 350° C. to 400° C., 340° C. to 380° C., etc. For example, the calcination temperature may be 340° C., 360° C., 380° C., 400° C., 420° C., 440° C., or 450° C.

In some embodiments, in step 2), the calcination time may be 3.5 h to 5 h, 3 h to 4.5 h, 3.5 h to 4 h, etc. For example, the calcination time may be 3 h, 3.5 h, 4 h, 4.5 h, or 5 h.

In some embodiments, in step 2), the stirring time is 10 h, the calcination temperature is 400° C., and the calcination time is 4 h.

By precisely controlling preparation parameters such as the stirring time, the calcination temperature, and the calcination time, physicochemical properties of the catalyst can be effectively regulated, such as uniform dispersion of metal components, a crystal structure, surface acid sites, and an electronic state. This enables the catalyst to directionally regulate hydrodeoxygenation activity and product selectivity of the biological oils, thereby improving selectivity of a target alkane component (e.g., pentadecane or hexadecane) and obtaining high-quality biodiesel.

By controlling the stirring time within a range of 8 h to 12 h, uniform and sufficient mixing of the nickel component with the atom-substituted zirconia support can be ensured, promoting good dispersion of the nickel component on the support and laying a foundation for subsequent formation of a stable nickel-oxygen-zirconium (Ni—O—Zr) interface. By controlling the calcination temperature within a range of 340° C. to 450° C., and supplementing with a calcination time of 3 h to 5 h, decomposition of a nickel precursor and formation of a suitable crystalline phase structure with the support are facilitated, while ensuring stable formation of the M-O—Zr coordination structure, thereby precisely modulating an electronic state and acid-base properties of the ZrO₂ support. The structure and surface properties of the catalyst can be effectively regulated, thereby achieving directional regulation of hydrodeoxygenation activity and product selectivity of the biological oils, and ultimately obtaining high-quality biodiesel.

The method for preparing biodiesel by directional regulating hydrodeoxygenation of biological oils provided in the present disclosure has the following beneficial effects.

(1) The present disclosure uses additives Ce and Ti to functionalize a support of a Ni/ZrO₂ catalyst to regulate chemical properties of the catalyst, achieving controllable regulation of hydrodeoxygenation activity and product selectivity of the biological oils, improving selectivity of a target alkane component, and obtaining high-quality biodiesel. Meanwhile, the present disclosure provides a manner for catalyst design for selective conversion in a hydrodeoxygenation system of biological oils, especially for product selection, which has many advantages such as cleanliness, high reserves, and low cost.

(2) In the present disclosure, Ce atom substitutes Zr atom and is inserted into ZrO₂ to form a Ce—O—Zr bond. Because an electronegativity of Ce (1.12) is lower than an electronegativity of Zr (1.4), electrons in the Ce—O—Zr bond are attracted by Zr, causing more electrons to accumulate around Zr. According to acid-base proton theory, electron enrichment on a catalyst surface forms Lewis acid sites, which directly facilitates adsorption of oxygen-containing groups in the biological oils. On the other hand, an electronic effect at the Zr—O—Ni interface effectively improves hydrogenation and C—C bond cleavage capabilities of the catalyst, giving the catalyst higher activity and decarboxylation selectivity.

In the present disclosure, Ti atom substitutes Zr atom and is inserted into ZrO₂ to form a Ti—O—Zr bond. Differently, an electronegativity of Ti (1.54) is higher than the electronegativity of Zr (1.4). Therefore, the Zr in the Ti—O—Zr bond is in an electron-deficient state, directly increasing a hydroxyl content on a surface of the ZrO₂ support. The hydroxyl groups on the catalyst surface can serve as Brønsted acid sites, improving ability of the catalyst to break C—O/C—O bonds, thereby obtaining higher HDO selectivity.

The ternary atom-substituted support loaded Ni catalyst composed of Ce, Ti, and Zr can modulate an electronic state and acidity of the ZrO₂ support itself by changing a ratio of Ce to Ti, thereby achieving directional regulation of hydrodeoxygenation activity and target products.

The technical solution of the present disclosure is further described below with reference to the accompanying drawings and examples.

To make objectives, technical solutions, and advantages of embodiments of the present disclosure clearer, the technical solutions in the embodiments of the present disclosure are clearly and completely described below with reference to the accompanying drawings in the embodiments of the present disclosure. Obviously, the described examples are a part of the embodiments of the present disclosure, not all of the embodiments.

### Example 1

Ni/1CeZrO₂ catalyst was prepared according to the following steps.

1) ZrO(NO₃)₂·xH₂O and Ce(NO₃)₃·6H₂O were mixed and dissolved in deionized water. An addition amount of Ce(NO₃)₃·6H₂O was 1 mol. %. A metal precursor salt solution with a concentration of 0.4 mol/L was obtained. 16.817 g of urea was added to the metal precursor salt solution and stirred thoroughly until completely dissolved to obtain a mixed solution.

Then, the obtained mixed solution was transferred to a 100 mL autoclave and heated at 150° C. for 12 h. After filtration and washing, a powder sample was dried overnight at 100° C., and then calcined at 600° C. in an O₂/Ar mixed atmosphere for 4 h to obtain 1CeZrO₂ support.

2) 1 g of the 1CeZrO₂ support and 1.23 g of Ni(NO₃)₂·6H₂O were added to a certain amount of the deionized water and stirred for 10 h. After rotary evaporation and drying overnight at 100° C., calcination was performed at 400° C. in the O₂/Ar mixed atmosphere for 4 h to obtain the Ni/1CeZrO₂ catalyst.

### Example 2

Ni/3CeZrO₂ catalyst was prepared, and the steps were the same as those in EXAMPLE 1, with the only difference being that an addition amount of Ce was changed to 3 mol. %.

### Example 3

Ni/5CeZrO₂ catalyst was prepared, and the steps were the same as those in EXAMPLE 1, with the only difference being that the addition amount of Ce was changed to 5 mol. %.

### Example 4

Ni/10CeZrO₂ catalyst was prepared, and the steps were the same as those in EXAMPLE 1, with the only difference being that the addition amount of Ce was changed to 10 mol. %.

### Example 5

Ni/1TiZrO₂ catalyst was prepared, and the steps were the same as those in EXAMPLE 1, with the only difference being that Ce(NO₃)₃·6H₂O was replaced with Ti(SO₄)₂.

### Example 6

Ni/5TiZrO₂ catalyst was prepared, and the steps were the same as those in EXAMPLE 5, with the only difference being that an addition amount of Ti was changed to 5 mol. %.

### Example 7

Ni/10TiZrO₂ catalyst was prepared, and the steps were the same as those in EXAMPLE 5, with the only difference being that the addition amount of Ti was changed to 10 mol. %.

### Example 8

Ni/15TiZrO₂ catalyst was prepared, and the steps were the same as those in EXAMPLE 5, with the only difference being that the addition amount of Ti was changed to 15 mol. %.

### Example 9

Ni/3Ce₇TiZrO₂ catalyst was prepared, and the steps were the same as those in EXAMPLE 1, with the only difference being that ZrO(NO₃)₂·xH₂O was mixed and dissolved in deionized water together with 3 mol. % of Ce(NO₃)₃·6H₂O and 7 mol. % of Ti(SO₄)₂.

### Example 10

Ni/5Ce₅TiZrO₂ catalyst was prepared, and the steps were the same as those in EXAMPLE 1, with the only difference being that ZrO(NO₃)₂·xH₂O was mixed and dissolved in the deionized water together with 5 mol. % of Ce(NO₃)₃·6H₂O and 5 mol. % of Ti(SO₄)₂.

### Example 11

Ni/7Ce₃TiZrO₂ catalyst was prepared, and the steps were the same as those in EXAMPLE 1, with the only difference being that ZrO(NO₃)₂·xH₂O was mixed and dissolved in the deionized water together with 7 mol. % of Ce(NO₃)₃·6H₂O and 3 mol. % of Ti(SO₄)₂.

### Comparative Example 1

Ni/ZrO₂ catalyst was prepared, and the steps were the same as those in EXAMPLE 1, with the only difference being that Ce(NO₃)₃·6H₂O was not added.

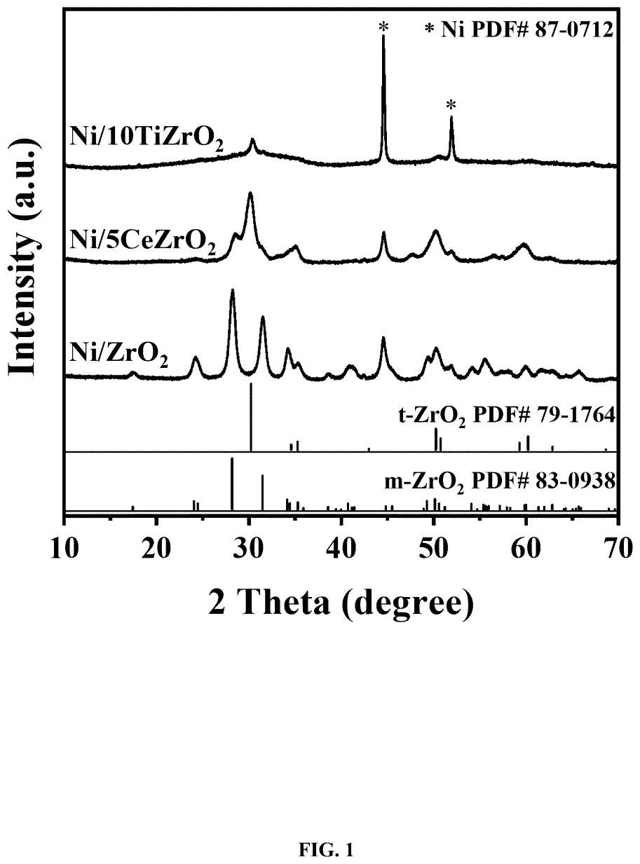

FIG. 1 is a X-ray diffraction pattern of the catalyst Ni/ZrO₂ of COMPARATIVE EXAMPLE 1, the catalyst Ni/5CeZrO₂ of EXAMPLE 3, and the catalyst Ni/10TiZrO₂ of EXAMPLE 7 according to the present disclosure.

In FIG. 1, an abscissa is labeled as “2 Theta” (i.e., 2 diffraction angle, with a unit of degree), and an ordinate is labeled as “Intensity” (i.e., diffraction intensity), with a unit of arbitrary units (a.u.).

The catalyst of COMPARATIVE EXAMPLE 1, the catalyst of EXAMPLE 3, and the catalyst of EXAMPLE 7 were tested and the test result is shown in FIG. 1. As shown in FIG. 1, by comparing XRD patterns of the three catalysts, it can be seen that after Ce and Ti are introduced, diffraction peaks attributable to CeO₂ and TiO₂ are not observed, and only a phase structure of the ZrO₂ support undergoes transformation and shift, indicating that Ce⁴⁺ and Ti⁴⁺ substitute Zr⁴⁺ and are successfully inserted into a ZrO₂ lattice, forming Ce—O—Zr and Ti—O—Zr coordination structures, rather than forming mixed oxides.

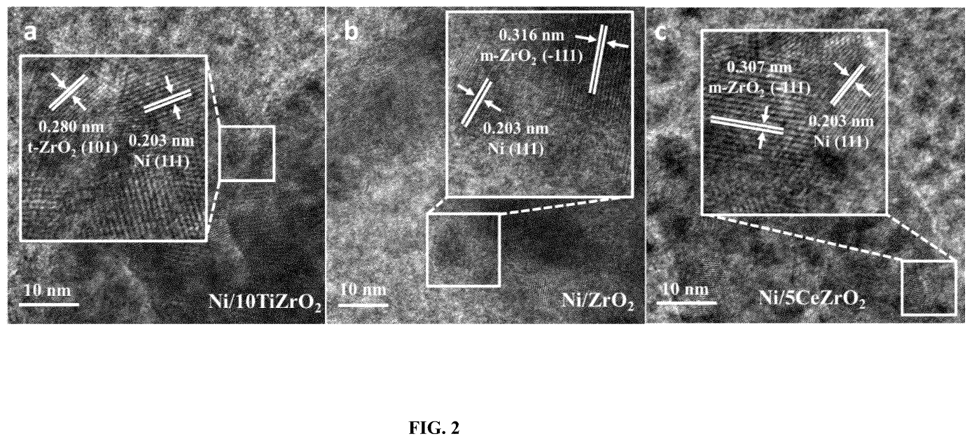

FIG. 2 is a TEM image of catalyst Ni/ZrO₂ of COMPARATIVE EXAMPLE 1, catalyst Ni/5CeZrO₂ of EXAMPLE 3, and catalyst Ni/10TiZrO₂ of EXAMPLE 7 according to the present disclosure, where a is Ni/10TiZrO₂, b is Ni/ZrO₂, and c is Ni/5CeZrO₂.

As shown in FIG. 2, by comparing TEM images of the three catalysts, lattice fringes (0.203 nm) corresponding to the Ni (111) plane are observed near ZrO₂ in the three catalysts, indicating that a Ni—O—Zr interface is formed between Ni and ZrO₂. In addition, in the catalyst Ni/5CeZrO₂, a lattice spacing (0.316 nm) of an m-ZrO₂ (−111) plane is observed to shrink to 0.307 nm. In the catalyst Ni/10TiZrO₂, a lattice spacing of a t-ZrO₂ (101) plane is observed to slightly contract compared to a lattice spacing (0.295 nm) in the standard card. Therefore, the results indicate that Ce and Ti are inserted into the ZrO₂ lattice to substitute Zr atom, forming Ni/ZrO₂ with Ce—O—Zr and Ti—O—Zr coordination structures, rather than forming a simple mixture of two oxides.

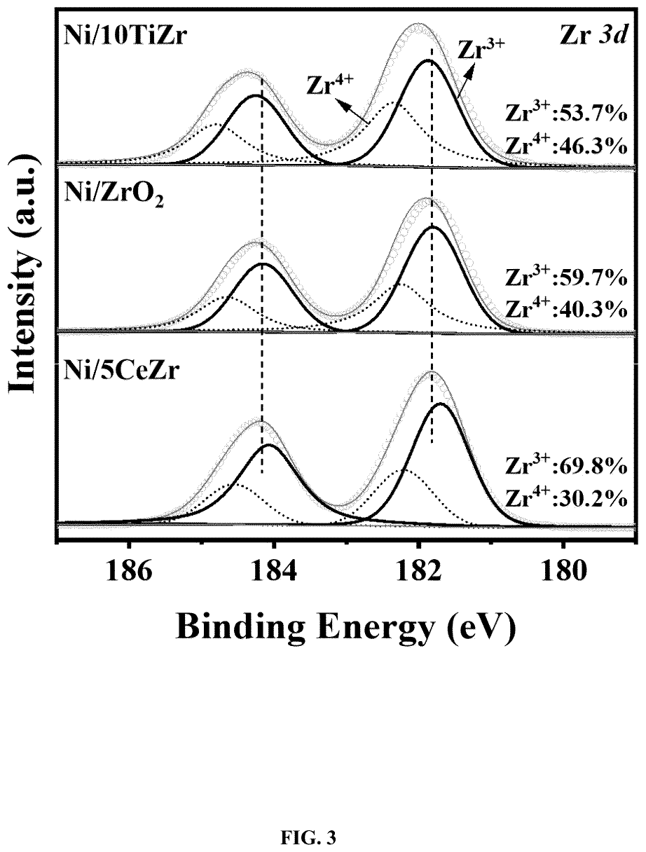

FIG. 3 is a XPS Zr 3d spectrum of the catalyst Ni/ZrO₂ of COMPARATIVE

EXAMPLE 1, the catalyst Ni/5CeZrO₂ of EXAMPLE 3, and the catalyst Ni/10TiZrO₂ of EXAMPLE 7 according to the present disclosure.

In FIG. 3, an abscissa is labeled as “Binding Energy”, with a unit of eV, and an ordinate is labeled as “Intensity”, with a unit of arbitrary units (a.u.).

As shown in FIG. 3, by comparing spectra of the three catalysts, the Zr 3d spectrum shows two distinct peaks at 181.8 eV and 184.1 eV, which are assigned 3d_{5/2} and 3d_{3/2} orbitals of Zr³⁺ species, respectively. After Ce is added, a binding energy of the Zr³⁺ species decreases. However, after Ti is added, the binding energy of the Zr³⁺ species increases. This is attributed to the fact that an electronegativity of Ce (1.12) is lower than an electronegativity of Zr (1.4), while an electronegativity of Ti (1.54) is higher than the electronegativity of Zr (1.4). Therefore, electrons in the formed Ce—O—Zr bond are attracted by Zr, while electrons around Zr in the formed Ti—O—Zr bond are dispersed, thereby changing an electronic state of ZrO₂ itself. This conclusion is also evidenced by contents of Zr³⁺ and Zr⁴⁺ species.

### Comparative Example 2

Ni/5CeO₂—ZrO₂ catalyst was prepared according to the following steps.

1) ZrO(NO₃)₂·xH₂O was formulated into a solution with a concentration of 0.4 mol/L. 16.817 g of urea was added to obtain a mixture, and the mixture was stirred thoroughly until completely dissolved to obtain a mixed solution. The obtained mixed solution was transferred to a 100 mL autoclave and heated at 150° C. for 12 h. After suction filtration, the obtained powder sample was dried overnight at 100° C. Then, the dried powder was dissolved in deionized water. 5 mol. % of Ce(NO₃)₃·6H₂O was added and stirred thoroughly for 6 h. After evaporation of the liquid, drying was performed overnight at 100° C., followed by calcination in an O₂/Ar mixed atmosphere at 600° C. for 4 h to obtain a 5CeO₂—ZrO₂ support.

2) 1 g of the 5CeO₂—ZrO₂ support and 1.2 g of Ni(NO₃)₂·6H₂O were added to a certain amount of the deionized water and stirred for 10 h. After rotary evaporation and drying overnight at 100° C., calcination was performed in an O₂/Ar mixed atmosphere at 400° C. for 4 h to obtain the Ni/5CeO₂—ZrO₂ catalyst.

### Comparative Example 3

Ni/10TiO₂—ZrO₂ catalyst was prepared, and the steps were the same as those in COMPARATIVE EXAMPLE 2, with the only difference being that Ce(NO₃)₃·6H₂O is replaced with Ti(SO₄)₂, with an addition amount of 10 mol. %.

The catalysts prepared in EXAMPLE 1-EXAMPLE 11 and COMPARATIVE EXAMPLE 1-COMPARATIVE EXAMPLE 3 were applied to directional regulation of hydrodeoxygenation of biological oils to prepare biodiesel, and specific steps were as follows.

A fixed-bed reactor was selected. Palm oil was dissolved in n-decane to obtain a palm oil solution with a mass concentration of 10 wt. %. The palm oil solution and hydrogen gas were mixed in a hydrogen-to-oil ratio of 300:1 and injected into the fixed-bed reactor loaded with an atom-substituted zirconia supported Ni catalyst to perform a hydrodeoxygenation reaction. An amount of the catalyst was 0.5 g, a reaction pressure was 0.2 MPa, a reaction temperature was 240° C., and a WHSV was 2 h⁻¹. The biological oils were catalytically hydrodeoxygenated to generate the biodiesel.

Specific reaction results are shown in the following table.

TABLE 1
COMPARISON OF CATALYTIC PERFORMANCE
OF CATALYSTS FROM DIFFERENT EXAMPLES
AND COMPARATIVE EXAMPLES

| | | | Selectivity | |
|---|---|---|---|---|
| | | Conversion | Penta- | Hexa- |
| | Catalyst | Rate/% | decane | decane |
| EXAMPLE 1 | Ni/1CeZrO₂ | 94.9 | 92.0 | 1.6 |
| EXAMPLE 2 | Ni/3CeZrO₂ | 96.8 | 92.4 | 2.7 |
| EXAMPLE 3 | Ni/5CeZrO₂ | 97.6 | 96.3 | 1.5 |
| EXAMPLE 4 | Ni/10CeZrO₂ | 93.6 | 95.4 | 2.8 |
| EXAMPLE 5 | Ni/1TiZrO₂ | 89.1 | 64.7 | 33.5 |
| EXAMPLE 6 | Ni/5TiZrO₂ | 88.6 | 40.5 | 57.4 |
| EXAMPLE 7 | Ni/10TiZrO₂ | 88.1 | 14.7 | 82.8 |
| EXAMPLE 8 | Ni/15TiZrO₂ | 37.7 | 18.9 | 62.3 |
| EXAMPLE 9 | Ni/3Ce7TiZrO₂ | 98.0 | 8.7 | 90.8 |
| EXAMPLE 10 | Ni/5Ce5TiZrO₂ | 98.7 | 15.9 | 83.5 |
| EXAMPLE 11 | Ni/7Ce3TiZrO₂ | 96.2 | 84.2 | 14.5 |
| COMPARATIVE | Ni/ZrO₂ | 85.0 | 75.7 | 6.3 |
| EXAMPLE 1 | | | | |
| COMPARATIVE | Ni/5CeO₂—ZrO₂ | 77.4 | 51.7 | 5.2 |
| EXAMPLE 2 | | | | |
| COMPARATIVE | Ni/10TiO₂—ZrO₂ | 57.5 | 20.8 | 17.9 |
| EXAMPLE 3 | | | | |

It can be seen from data in Table 1 that the characterized bond-bridge modulation may indeed significantly improve activity of the Ni/ZrO₂ catalyst and achieve controllable regulation of product selectivity. Taking unmodified Ni/ZrO₂ as a benchmark (a conversion rate of 85.0%, a pentadecane selectivity of 75.7%, a hexadecane selectivity of 6.3%), the Ce—O—Zr bonds formed by doping Ce atom significantly improves hydrodeoxygenation activity and enhances decarboxylation (DCO, generating pentadecane) selectivity. For example, the conversion rate of Ni/5CeZrO₂ reaches 97.6%, with the pentadecane selectivity as high as 96.3%, and the hexadecane selectivity only 1.5%, whereas Ni/1-3CeZrO₂ (the conversion rate of 94.9%-96.8%) all also exhibit high pentadecane selectivity (approximately 92%) This indicates that electron migration from Ce to Zr facilitates enrichment of electrons around Zr, promotes adsorption of oxygen-containing groups in the biological oils, and maintains Ni sites in a reduced state through a Zr—O—Ni interface, thereby improving H₂ dissociation and C—C bond cleavage, and promoting dominance of the DCO pathway.

In contrast, the Ti—O—Zr bonds formed by introducing Ti alone obviously favors HDO (generating hexadecane) selectivity, but its effect on overall conversion rate is nonlinear. Low Ti content (Ni/1TiZrO₂) already increases the hexadecane selectivity to 33.5%. As the Ti content increases, the hexadecane selectivity continues to rise (the hexadecane selectivity of 57.4% for Ni/5TiZrO₂, the hexadecane selectivity of 82.8% for Ni/10TiZrO₂). This indicates that Ti—O—Zr bonds lead to an increase in hydroxyl groups and Brønsted acid sites on the support surface, promoting C—O/C—O cleavage to follow the HDO pathway. However, when Ti is excessive (Ni/15TiZrO₂), the total conversion rate decreases significantly (37.7%). This suggests that excessive Ti can damage overall distribution of active sites or pore structure of the support, reducing catalytic efficiency.

Co-doping of Ce and Ti can achieve precise regulation between activity and selectivity. Different Ce/Ti ratios exhibit significantly different selectivity trends. For example, Ni/3Ce₇TiZrO₂ exhibits a product distribution dominated by HDO (the hexadecane selectivity of 90.8%, the pentadecane selectivity of only 8.7%) while ensuring an extremely high conversion rate (98.0%), whereas Ni/7Ce₃TiZrO₂ achieves a product distribution dominated by DCO (the pentadecane selectivity of 84.2%, the hexadecane selectivity of 14.5%) under a high conversion rate (96.2%). Ni/5Ce₅TiZrO₂ (the conversion rate of 98.7%, the hexadecane selectivity of 83.5%) further suggests that high activity and a product distribution dominated by HDO can also be achieved with equal-proportion co-doping. In comparison, using simple composite oxides as supports (Ni/5CeO₂—ZrO₂, Ni/10TiO₂—ZrO₂) fails to form the aforementioned bond-bridge structure, and the conversion rates (e.g., the conversion rate of only 77.4% for Ni/5CeO₂—ZrO₂, the conversion rate of only 57.5% for Ni/10TiO₂—ZrO₂) are significantly lower than those of corresponding doped solid solutions, thus, the same degree of directional regulation can not be achieved.

In summary, it can be seen from Table 1 that using a Ni/ZrO₂ supported catalyst, by introducing Ce atoms and Ti atoms into a ZrO₂ lattice to replace Zr atoms to form corresponding Ce—O—Zr and Ti—O—Zr bonds, the electronic state and chemical properties of the ZrO₂ support itself are modulated through bond-bridge modulation, thereby directionally modifying the Ni/ZrO₂ catalyst. This achieves controllable regulation of hydrodeoxygenation activity and product selectivity for the biological oils. In the process of catalyzing hydrodeoxygenation of the biological oils to generate the biodiesel, electron migration from Ce to Zr in the Ce—O—Zr bonds enriches more electrons around Zr. On the one hand, this facilitates adsorption of oxygen-containing groups in the biological oils. On the other hand, the electronic effect at the Zr—O—Ni interface promotes electron rearrangement of Ni sites to Ni⁰, enhancing H₂ dissociation and C—C bond cleavage, thereby improving hydrodeoxygenation activity and DCO selectivity. In the Ti—O—Zr bonds, enrichment of electrons around Zr by Ti increases the hydroxyl group content on the surface of the ZrO₂ support, thereby enriching Brønsted acid sites on the catalyst surface, promoting C—O/C═O cleavage, and thereby improving HDO selectivity. In contrast, Ni/5CeO₂—ZrO₂ and Ni/10TiO₂—ZrO₂ catalysts using simple composite oxides as supports can not form corresponding bonds, thus, directional regulation of hydrodeoxygenation activity and product selectivity for the biological oils cannot be achieved.

Therefore, the present disclosure provides a method for preparing biodiesel by directional regulating hydrodeoxygenation of biological oils. By using additives Ce and Ti to functionalize the support of the Ni/ZrO₂ catalyst, chemical properties of the catalyst are regulated, achieving controllable regulation of hydrodeoxygenation activity and product selectivity for the biological oils, improving selectivity of a target alkane component, and obtaining high-quality biodiesel. Meanwhile, the present disclosure provides an approach for design of catalysts for selective conversion in the hydrodeoxygenation system of the biological oils, especially for product selection, which has many advantages such as cleanliness, high reserves, and having low cost.

Finally, it should be noted that the above embodiments are only used to illustrate the technical solutions of the present disclosure and not to limit the technical solutions of the present disclosure. Although the present disclosure has been described in detail with reference to preferred embodiments, those of ordinary skill in the art should understand that modifications or equivalent replacements to the technical solutions of the present disclosure still may be made.

These modifications or equivalent replacements also may not cause the modified technical solutions to depart from the spirit and scope of the technical solutions of the present disclosure.

What is claimed is:

1. A method for preparing biodiesel by directional regulating hydrodeoxygenation of biological oils, the method comprising:
dissolving the biological oils in a solvent to obtain an oil mixed solution with a mass concentration of 1.0% to 20%; mixing the oil mixed solution with hydrogen gas to obtain a mixture and injecting the mixture into a fixed-bed reactor; performing a hydrodeoxygenation reaction using an atom-substituted zirconia supported Ni catalyst; controlling the biological oils to directionally generate alkanes having corresponding carbon numbers or alkanes having one less carbon atom by changing a coordination structure of a support and heteroatoms in the atom-substituted zirconia supported Ni catalyst; and obtaining the biodiesel; wherein
a chemical formula of the atom-substituted zirconia supported Ni catalyst is Ni/xMZrO₂, where x is a molar percentage of M in the support and has a value of 1% to 20%; M is at least one of Ce or Ti; and a loading amount of Ni is 5 wt. % to 50 wt. %; and
the atom-substituted zirconia supported Ni catalyst is prepared by a process including:
1) mixing and dissolving at least one of a zirconium salt, a cerium salt, or a titanium salt in deionized water to obtain a metal precursor salt solution; adding urea to the metal precursor salt solution and stirring thoroughly until dissolution is completed to obtain a metal precursor mixed solution; placing the metal precursor mixed solution in an autoclave for heating, and filtering to obtain a precipitate; washing and drying the precipitate; and calcining the precipitate in an O₂/Ar mixed atmosphere to obtain an atom-substituted zirconia support; and
2) adding the atom-substituted zirconia support and a nickel salt to the deionized water, stirring uniformly, performing rotary evaporation and drying, and then calcining in the O₂/Ar mixed atmosphere to obtain the atom-substituted zirconia supported Ni catalyst.

2. The method of claim 1, wherein the zirconium salt is ZrO(NO₃)₂·xH₂O, the cerium salt is Ce(NO₃)₃·6H₂O, and the titanium salt is Ti(SO₄)₂.

3. The method of claim 1, wherein in step 1), a molar ratio of the urea to the metal precursor salt solution is 10:1, a heating temperature of the autoclave is 120° C. to 180° C., a heating time of the autoclave is 10 h to 20 h, a calcination temperature is 500° C. to 650° C., and a calcination time is 3 h to 5 h.

4. The method of claim 3, wherein the heating temperature of the autoclave is 150° C., the heating time of the autoclave is 12 h, the calcination temperature is 600° C., and the calcination time is 4 h.

5. The method of claim 1, wherein in step 2), a stirring time is 8 h to 12 h, a calcination temperature is 340° C. to 450° C., and a calcination time is 3 h to 5 h.

6. The method of claim 5, wherein the stirring time is 10 h, the calcination temperature is 400° C., and the calcination time is 4 h.

7. The method of claim 1, wherein the biological oils are at least one of palm oil, soybean oil, or rapeseed oil.

8. The method of claim 1, wherein the solvent is at least one of n-decane, cyclohexane, or n-heptane.

9. The method of claim 1, wherein before the hydrodeoxygenation reaction, the atom-substituted zirconia supported Ni catalyst is subjected to in-situ reduction in the fixed-bed reactor for 1.5 h to 2.5 h at a reduction temperature of 300° C. to 400° C.

10. The method of claim 1, wherein during the hydrodeoxygenation reaction, a concentration of the biological oils is 1.0 wt. % to 20 wt. %, a temperature is 160° C. to 300° C., a hydrogen pressure is 0.2 MPa to 4 MPa, a weight hourly space velocity is 0.2 h⁻¹ to 4.8 h⁻¹, and a ratio of the hydrogen gas to the biological oils is 200:1 to 800:1.
